(19) United States
(12) Patent Application Publication
(10) Pub. No.: US 2013/0339857 A1
(43) Pub. Date: Dec. 19, 2013

(54) Modular and Scalable Interactive Video Player

(71) Applicant: The Mad Video, Inc., San Francisco, CA (US)

(72) Inventors: Koldo Garcia Bailo, San Francisco, CA (US); Raul Medina Beltran de Otalora, Madrid (ES); Ludo Bermejo Fernandez, Madrid (ES)

(21) Appl. No.: 13/919,804

(22) Filed: Jun. 17, 2013

Related U.S. Application Data
(60) Provisional application No. 61/660,113, filed on Jun. 15, 2012.

(51) Int. Cl. G06F 3/0484

(52) U.S. Cl. CPC G06F 3/0484
USPC 715/723

(57) ABSTRACT

Interactive videos are displayed to a user by adding annotations to a non-interactive video. During video playback, hotspots are displayed on a portion of the video that a viewer interacts with to access annotations relating to the hotspot. The hotspot indicates an element or object of the video that are interactable by the user. The annotation data and hotspot information is separately stored from the underlying video, enabling the annotation and hotspot information to be modified without editing the underlying video, and enabling the annotation to be accessed from a separate system from the location of the video. In this way, viewers can obtain additional data about any element, including, but not limited to, people, products, and places, appearing within the video at any moment, simply by clicking on a hotspot relating to these elements.

### CROSS REFERENCE TO RELATED APPLICATIONS

This application claims the benefit of U.S. Provisional Application No. 61/660,113, filed Jun. 15, 2012, which is incorporated by reference in its entirety.

### BACKGROUND

This invention relates generally to displaying videos to a user and more particularly to video annotations.

The subject matter discussed in this section should not be assumed to be, nor construed as, prior art merely because it is mentioned in the Background section. Similarly, problems discussed in this section or associated with the subject matter of the Background section should not be assumed to have been previously recognized as prior art.

Modern technology enables providing video content to viewers over the Internet. Content delivered through the Internet is quickly changing from textual- and image-based content (static) to video-based content (dynamic). Video websites enable users, professional and amateur, to produce and share creative content to be viewed by potentially millions of viewers.

Advertising associated with videos, however, is often out-of-place, ill-suited and not well-received. Advertisements may be presented as banners at the bottom of a video or as a pop-up at the beginning of a video. These current advertisements associated with video-based content primarily focus on adding these awkward elements into the video. Viewers do not generally welcome such intrusive advertisements because they harm their viewing experience.

Furthermore, the process of matching an advertisement to content is based on identifying relevant keywords within a website, and not necessarily addressing the content of the video, which is often completely irrelevant to the advertisement, thereby exacerbating any annoyances the viewer already has regarding the presence of advertisements within the video. Another drawback to this advertising strategy is that the these “pop-ups” in the videos (usually a link at the bottom of the video), in addition to typically being totally irrelevant to the video, requires the viewer to click the pop-up, which then takes the viewer away from the video (such as to a third-party website), even furthering their annoyance. Accordingly, viewers learn to avoid these pop-ups, ignore them, or navigate away from a video when a pop-up appears.

In view of the foregoing, there is a need for new technology to enable a better insertion of relevant information, such as, but not limited to, advertisements, into videos. There is a need for video play back which contains information, including advertising, that are interactive, nonintrusive, and actually fun and enjoyable for the viewer, and which increases viewer engagement time with the video. Further, there is a need for a modular and scalable solution to support as many interactive features (current and future) of interactive video as possible, as well as the ability to integrate the ever-growing list of online delivery networks, online video sharing service providers, third party content feeds, and social media networks.

### SUMMARY

In view of the foregoing disadvantages inherent in known conventional systems, the present disclosure provides software capable of allowing viewers to interact with videos and play back interactive videos in multiple ways. This system uses a modular and scalable solution, which supports interactive video features, and is used with content delivery networks, online video sharing service providers, third party content feeds and social media networks, and can grow in a streamlined way by developing individual and independent modules in order to support current as well as new functionalities and delivery networks as they develop. The subject matter discussed herein merely represents different approaches, which in and of themselves may also be inventions. Furthermore, the selected names, titles, headings and the like shall not be construed so as to limit or restrict the scope of the disclosure embodiments.

More specifically, an interactive video player allows play back of videos of non-interactive videos that may be hosted by a third party online video sharing service provider, and provides annotated information about any object, person, place or action happening in the particular time frame of the video they are viewing. These interactive elements in a video are termed “hotspots.” Users interact with the hotspot by clicking on or selecting the hotspot, which provides more detailed information about the hotspot. For example, a hotspot highlighting a person may describe the person's background, while a hotspot highlighting a location may describe the location and a further interaction may show a map of the location. The hotspots may also be used to navigate within a video or to linked media content, and the hotspots may be directly shared with users via a social network or via a link to the hotspot and the video.

The interactive video player is a modular architecture that enables the system to support new interactive features and experiences, new video content providers and content delivery networks, online video sharing service providers, analytics service providers, publishing options, and play back devices without affecting other portions of the system. In addition, interactive video can be embedded within a video or separately stored at an external site.

More specifically, the interactive video player of the present invention offers a unique playback experience for viewers. In other words, the same non-interactive video with the same annotations data can result in many different user experiences, because the interaction and layout settings are independent and can be individually created. For example, a viewer can play back an interactive video, and if something within the video at a particular scene catches his interest, he can roll his mouse curser over the video or click the relevant element (i.e., the hotspot), depending on the interaction settings of the particular Interactive Video, within the video, and data (i.e., “annotation data”) will appear relevant to what captured his attention. The annotation data is displayed if it is available at a specific time within the video (e.g., at 2:42, or the 2 minute, 42 second mark). The viewer accesses additional information about the annotated item by interacting with the hotspot to receive annotation data.

Annotation data is related to specific elements within the video, such as a location, person, or object, among others. The annotation data may be statically defined, or the annotation data defines a location to remotely access more detailed information, such as a social networking feed, a content management system API, etc. or other data source that may be accessed from a third party systems (e.g., an e-commerce platform, a social networking system, a news feed, etc.) If the viewer wants to find more data or interaction possibilities with the annotation data, he can interact with (e.g., click/tap on or select) the hotspot to discover additional information about the annotation data. The additional information may be separately defined from the initial annotation data. For example the initial annotation data may be statically defined while the additional data is updated based on information retrieved from the third party system.

Further, a viewer can open the hotspot to discover more information about the specific hotspot from a third party website, share the hotspot on a social network site or resume video playback by closing the hotspot and returning to the video playback.

In one embodiment, the system isolates the interaction data from the video content itself, allowing several different user experiences with the same video content. Various types of interaction data may be used for the same video, allowing a selection of interaction data based on the user's location, for example. The same concept applies to how the data is shown or presented to the viewer, allowing different visualizations (i.e., “look and feel”) of the same non-interactive video content and Annotation Data. The system further provides multi-country and multi-language support, as described in more detail below.

In one embodiment, the system collects user interaction information to track and log data (e.g., viewers' interaction data, geo-location data, etc.) about any viewer that played back the interactive video, including, but not limited to, what hotspots were most often selected, and what visualizations were preferred.

Further aspects of the invention will become apparent from consideration of the drawings and the ensuing description of preferred embodiments of the invention. In this respect, before explaining at least one embodiment of the invention in detail, it is to be understood that the invention is not limited in its application to the details set forth in the following description. A person skilled in the art will realize that other embodiments of the invention are possible, and that the details of the invention can be modified in a number of respects, all without departing from the inventive concept. Also, it is to be understood that the phraseology and terminology employed herein are for the purposes of description, and should not be regarded as limiting. Thus, the following drawings and description are to be regarded as illustrative in nature, and not restrictive.

### BRIEF DESCRIPTION OF THE DRAWINGS

FIG. 1A is a diagram of an environment for providing interactive video to users of a user device according to one embodiment

FIG. 1B further illustrates starting display of an interactive video using modules within a composer according to one embodiment.

FIG. 1C shows an interactive video player container located in a host web page according to one embodiment.

FIG. 2 shows the functional connection between components of the interactive video player.

FIG. 3 illustrates the architecture of the layout and interaction module according to one embodiment.

FIG. 4 shows screenshots of interactive video according to one embodiment.

FIG. 5 illustrates a variety of navigation layouts according to various embodiments.

FIG. 6 shows a further layout of hotspots for user interaction with an interactive video according to one embodiment.

FIG. 7 shows screenshots with example interactions of hotspots with a viewer according to one embodiment.

FIG. 8 illustrates screenshots of an example modification of a webpage based on an interaction event according to one embodiment.

FIG. 9 illustrates an example statistical report of user analytics according to one embodiment.

FIG. 10 illustrates another example statistical report of user analytics according to one embodiment.

FIGS. 11 and 12 illustrate additional example statistical reports of user analytics according to one embodiment.

FIGS. 13A and 13B show examples of interactive video playback associated interactions according to one embodiment.

FIG. 14 displays a series of images that show a method of sharing according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

This disclosure describes the display of interactive video content to viewers of the video. When the viewer watches the video, portions of the video, termed “hotspots,” are associated with annotated data. The user may interact with the hotspot to receive additional annotations and further information about the item in the video. For example, a person may be shown in a video skateboarding down a hill. Multiple pieces of annotated content may be shown to the user during the scenes of the video and appear as relevant to the viewer. When the person appears, a hotspot indicating the person's name may be interacted with to display additional information about that person. When the hill is shown, a hotspot showing the location of the hill may be interacted with by the user to describe the area and provide a map of that area. The skateboard of the user may also be associated with a hotspot that describes the skateboarding brand and may provide an opportunity for the viewer to purchase the skateboard. Hotspots may also provide additional details linking a user to view a product at a webpage or to view a similar hotspot in another video. Each hotspot is shown and removed as the related items are shown on the video.

In one embodiment, the video content is not interactable and video annotation content is overlaid on the non-interactable video content to create an interactable video. Thus, the video content and video annotation content may be stored separately. The video annotation content is accessed and applied to the display of the video content. This allows the annotation content to dynamically change without requiring any modification of the video content, as well as allowing different definitions of annotated content for the same video. In this way, the annotated content is modular with respect to attaching annotations with the underlying video.

For purposes of this disclosure, a non-interactive video is a video that does not include interactive components, such as the raw or original video stored at a content management system.

For purposes of this disclosure, an interactive video is a digital video that supports a viewer's interaction with annotations while viewing the video. The interactive video plays like regular video files, but includes clickable or touchable areas, or hotspots, that perform an action when you click on or touch them. For example, when a viewer clicks on a hotspot with his cursor mouse or touches a hotspot with his finger, the video may display information about the object he clicked on, jump to a different part or element of the video, or open an entirely new video file according to the interactive annotation.

For purposes of this disclosure, a hotspot is an interactive content item that is interactable (i.e., by a user clicking or touching) in an area within an interactive video. The hotspot appears where annotation data is located within the interactive video. A hotspot can be placed and shown on any element within an interactive video, such as, but not limited to, a tangible non-moving object, a tangible moving object, a person, a product, a place, the background music, etc., subject to be annotated as interactive content within an interactive video. A hotspot may also be searchable as a “tag.”

For purposes of this disclosure, a tag is a keyword or term assigned to a piece of information (e.g., a hotspot, image, or video, among others). A tag describes an item and is searchable or browsable to obtain additional videos or annotations with the same tag. When the interactive video is created, tags may be added to a hotspot image, video, or other interactive element. For purposes used herein, “tag” may be used as a noun or a verb and in different variations thereof (i.e., “tagged,” “tags, “tagging”).

For purpose of this disclosure, a “Viewer” is the individual who is watching, viewing, or interacting with Interactive video. A viewer can be the general viewing public or general audience of a video.

For purposes of this disclosure, an “event” is an action that is initiated inside the interactive video player and is handled by a piece of code outside of the system of the present invention. Typically, “events” are handled synchronously with system workflow (i.e., the interactive video player has one or more dedicated places where events are handled.) Typical sources of events include the viewer, who clicks on a Hotspot 500, touches a Hotspot 500 with his finger, or simply rolls his mouse cursor over a video or specific area in a video, etc. A website which changes its behavior in response to events is said to be event-driven, often with the goal of being interactive. Events may be transmitted to an external system such as a website embedding the Interactive Video Player Container. The website may use the events to affect operation of the website, such as changing the appearance or function of the website as described below. Events may be received from the website and affect operation of the interactive video player, such as changing playback of the video, opening a hotspot, or opening the hotspot to a specific time.

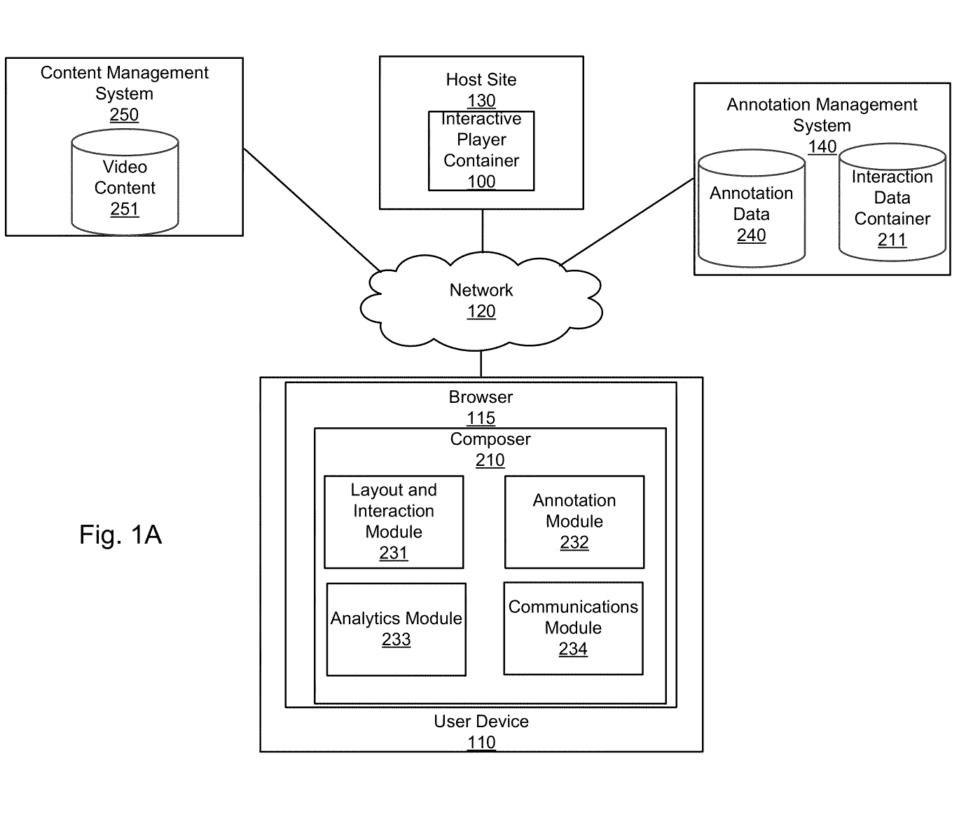

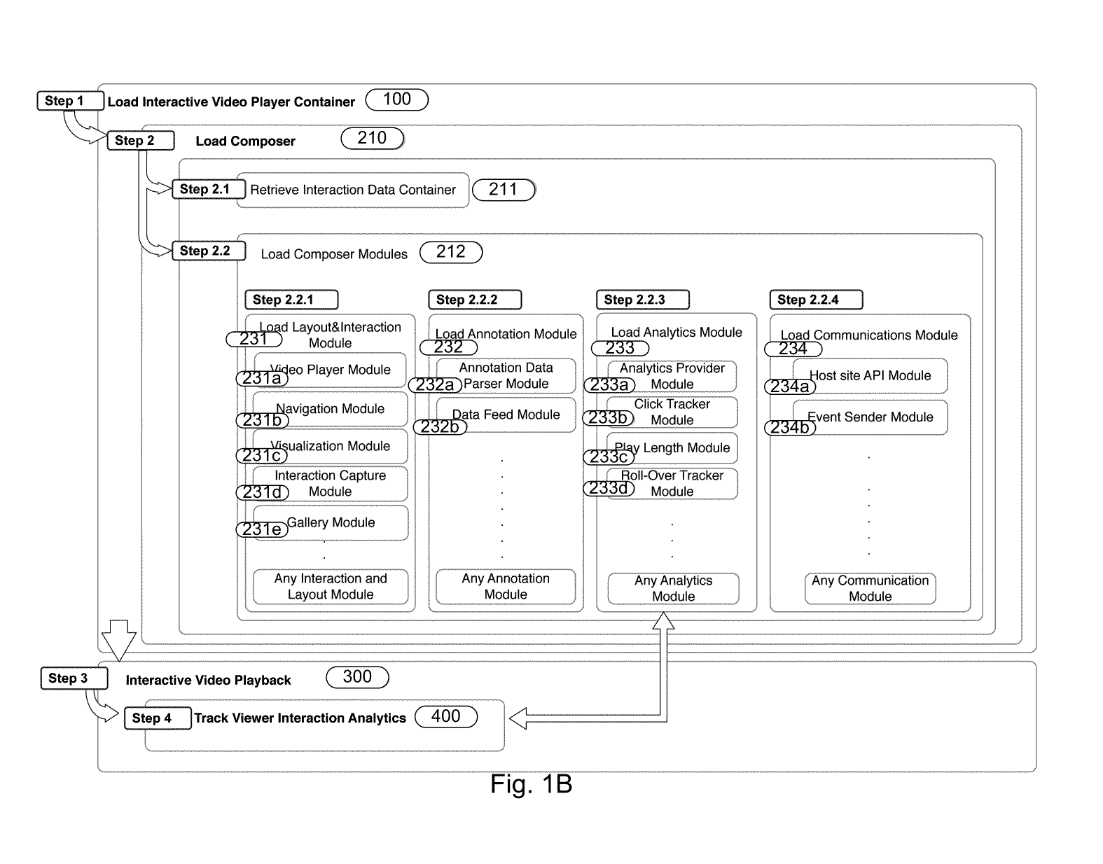

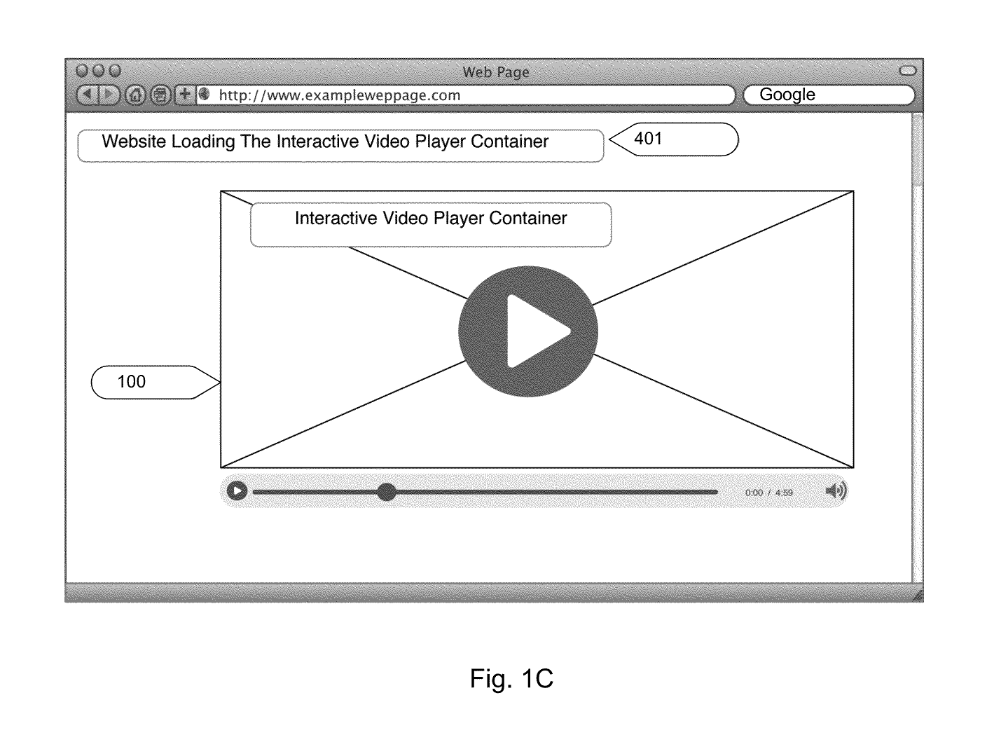

FIG. 1A is a diagram of an environment for providing interactive video to users of a user device 110 according to one embodiment. The user device 110 communicates with various systems including a host site 130, a content management system 250, and an annotation management system 140 through a network 120.

The user device 110 in this embodiment is any suitable computing device for accessing a host site 130, displaying a video, and providing annotations on the video as further described below. Examples of such computing devices include personal computers like desktop or laptop computers, tablet computers, smartphones, and other systems with a display that can receive user input and provide videos to the user. In this embodiment, the user device 110 accesses a host site 130 using a browser 115 to access a page on the host site 130. The page on the host site includes an interactive player container 100 that is accessed by the browser 115.

The interactive video player container 100 is a component that directs user device 110, and more specifically browser 115 to instantiate a composer 210 that composes video and annotations for presentation to the user and otherwise manages the annotation system. The interactive player container 110 may also include a parameter directing the browser or composer 210 to access annotation management system 140 to access an interaction data container 211 and annotation data 240. The Interactive Video Player Container 100 may be instantiated differently based on the user device 110 and the browser 115, and thereby allows the Interactive Video Player to function across different platforms and technologies.

The composer 210 receives a designated interaction data container 211 from the host site 130 or from the instructions in the interactive player container 100 and retrieves the Interaction Data Container 211 from the annotation management system 140 that stores the interaction data container 211. The interaction data container 211 includes instructions to load further modules, such as a layout and interaction module 231, an Annotation Module 232, an analytics module 233 and communications module 234) and thus, “compose” an interactive video player. A module is self-contained unit of a system, such as an assembly of components or sub-modules, which performs a defined task and can be linked with other such Modules to form a larger system. The composer 210 loads each module and their respective properties as specified in the interaction data container 211 in order to play back the interactive video.

The interaction data container 211 is a data structure (i.e., data file) that contains the settings for the layout and interaction module 231, annotation module 232, analytics module 233 and communications module 234 to be instantiated by the composer 210. The system composer 210 uses the interaction data container 211 to load the necessary modules 212 to be able to play back an interactive video. The interaction data container 211 contains interaction data specifying the layout and interaction settings, annotation data settings, analytics settings, and communications settings. Further, the interaction data designates to the Annotation Module 232 what data must be fetched and from where (e.g., from a file, embedded as part of the interaction data itself, or from an external system API). The interaction data may also include the annotation data 240, or may specify the network location of annotation management system 140 that includes the annotation data for the selected video. Thus, the interaction data includes the data required by the composer 210 to load suitable modules in order to initiate interactive video playback. Interaction Data 200 lets the Composer 210 know which Modules to load, and how (i.e., the “settings” of each particular Module.).

The layout and interaction module 231 is loaded by composer 210 to support the interaction and layout settings suitable for a specific interactive video. The layout and interaction module 231 manages the layout of annotation elements with the video and provides input and output

The annotation module 232 is loaded by the composer 210 to retrieve the annotation data 240 of an interactive video or for a particular hotspot in a video. The annotation module retrieves annotation data and provides the annotation data to the layout and interaction module 231. Annotation data 240 is any data selected by a content creator for placement at a hotspot in a video. The possible annotation data includes but is not limited to, an image, a text description, a video, a location on a map (including a link to a mapping service), and a third party data feed (e.g., a social networking feed, a book review feed, a news fee, and a product catalog). The annotation module 232 accesses and parses the annotation data 240. The annotation data 240 can be located, among others, in an external file at a dedicated annotation management system 140 (as shown in FIG. 1A), embedded as part of the interaction data itself, or in a content management system 250.

The analytics module 233 is loaded by the composer 210 to track the viewer's interactions with the video as well as send the tracking data to an analytics service (not shown in FIG. 1A) to analyze the user interactions with a support the Viewers' interaction tracking data, as well as facilitate sending said tracking data to an Analytics service suitable for a specific Interactive video.

The communications module 234 is loaded by the Composer 210 communicate with the website loading the interactive video player container 100, where applicable. Such communication may be to notify the host site 100 of an interaction event, such as a user interacting with a particular annotation. The communications module 234 may also receive events from the host site 100, such as user interaction with the host site.

For purposes of describing the present invention, a “Timeline Video” is a format of Interactive video. In a Timeline Video, whenever a Viewer “rolls over” the Interactive video with his mouse cursor, he sees Hotspots 500 as a list; however, he has no information about the place where Hotspots 500 are located (i.e., the positioning of the Hotspots 500 within the Interactive video).

The content management system 250 a computer system that allows publishing, editing and modifying of video content 251 as well as site maintenance from a central page. The video content 251 stored at the content management system 250 is accessible by the user device in one embodiment via a content delivery API. The content delivery API is an Application Programming Interface (“API”) provided by the content management system, such as an online video sharing service provider or content distribution networks, specifically designed to allow external systems (such as websites, software applications or devices) to integrate video content and functionality.

Though shown here as several discrete systems, in various embodiments, the functions of content management system 250, host site 130, and annotation management system 140 may be combined to a single system. For example, a single integrated video annotation system may provide the interactive player container 100, the interaction data container 211, and the video content 251. In other embodiments, the rather than the interactive video player playing back videos hosted by third party online video sharing service providers, the video source may also be accessed without a network and from an offline source (e.g., a hard drive, Blu-ray discs, DVDs, etc.). As the annotation data is overlaid on the video, separate annotation data can be selected and played with an offline source, such as a DVD, without modifying the DVD or other offline source of the video.

In another embodiment, the interactive video player is implemented as a “plug-in” that will allow third party online video players that are able to support extensions as plug-ins to play interactive videos as well by implementing the composer interface as an extension to the plug-in. This allows these third party platforms (i.e., those that are able to support extensions as plug-ins) to implement annotations according to this disclosure.

### System Overview

FIG. 1B further illustrates starting display of an interactive video using modules within the composer 210 according to one embodiment. To initiate playback of an interactive video in this embodiment, four main steps are involved, as described in more detail below and illustrated in FIG. 1b: 1) load the interactive video player container 100; 2.) load the composer 210; 3) initiate interactive video playback 300; and, 4) track viewer interaction analytics 400.

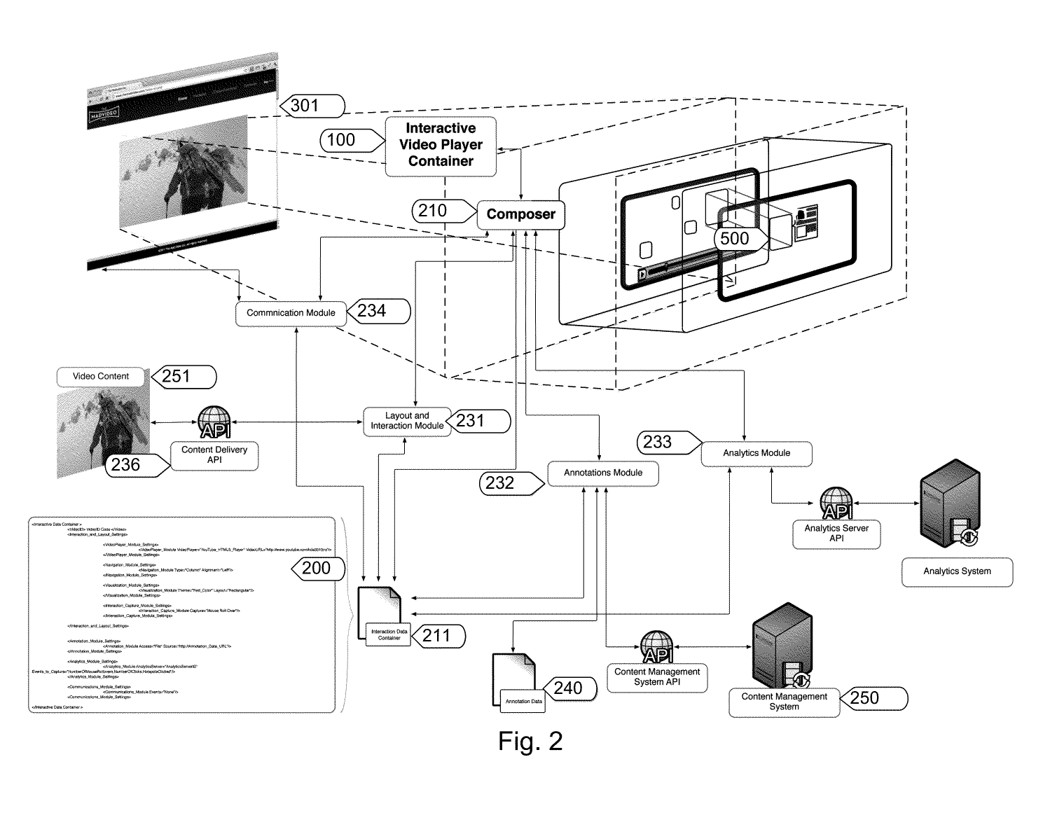

First, and referring to FIG. 1b, the interactive video player container 100 is loaded by the browser accessing the host site 130. Loading the interactive video player container 100 is shown as Step 1 of FIG. 1B, so that the interactive video, as shown in FIG. 2, can appear on browser 115. Alternatively, the interactive video player is an Interactive Video Player app for a Smart TV, a native Interactive Video Player for mobile devices, or any other relevant technology for a suitable user device 110 platform, now existing or later invented.

The way the Interactive video player container 100 is implemented will vary depending on the embodiment, depending on technology, platform, device or field of application, such as, but not limited to, web browsers, mobile devices, connected TVs, etc. For the embodiment of playing back an interactive video from a web browser 115, the web browser 115 loads the interactive video player container 100 to allow it to play back the interactive video. The interactive video player container 100 identifies the location of interaction data container 211, which specifies where the interaction data can be found. The web browser 115 loads the interactive video player to allow it to play back the interactive video as further shown in FIG. 2. The web browser implementation of the Interactive Video Player Container 100 can occur in one of two ways:

In one embodiment of the web browser implementation, the web browser loads the interactive video player container 100 by accessing a specific URL where the interactive video player container 100 is available, such as:
http://MadPlayer_Container_URL?url=http://interaction_data_container_URL.

FIG. 1C shows an interactive video player container located in a host web page according to one embodiment. In this alternative method of loading the interactive video player container 100, an iFrame (i.e. an “inline frame”) embeds the interactive video player container 100 into a host 401 web page, as shown in FIG. 1C. An iFrame is an HTML document embedded inside another HTML document on a website. The iFrame HTML element is often used to insert content from another source, such as an advertisement, into a web page. In order to load the interactive video player container 100 in an iFrame, the website embeds specific HTML code in the website HTML. An example would be the following code:
<iframe_id=“containerMadVideoPlayer”
src=“MadPlayer_Container_URL?url=http://interaction_data_container_URL″></iframe>

The interactive video player container 100 allows the system to function across different platforms and technologies. For example, to load the interactive video player container 100 in a smart phone, a specific interactive video player container 100 supporting that particular technology will be loaded that may differ from the interactive video player container 100 on a tablet computer..

Next, referring again to FIG. 1B, the composer 210 must be loaded. The composer 210 expects one input file location specifying the interaction data container 211 (e.g., a URL). Once loaded, the composer 210 retrieves the interactive data container 211 to load the appropriate composer modules 212. The interaction data container 211 contains all the interaction data used by the composer 100 to instantiate the appropriate Modules 212. The interaction data (contained in the interaction data container 211) specifies the online video's location (e.g., a link to a video hosting service); the graphical templates location (which defines the appearance of components of the Annotation Data 240); the configuration file's location (which defines the interaction settings and user experience); as well as the Annotation Data 240 describing annotations to the video.

FIG. 2 shows the functional connection between components of the interactive video player. Referring to in FIG. 2, the interaction data container 211 specifies all the commands that the Composer 210 has to acknowledge; these commands are referred to herein as Interaction Data 200. The composer 210 retrieves the Interaction Data Container 211, as shown in FIG. 1B and FIG. 2. Then, continuing to refer to FIG. 1B and FIG. 2, the composer 210 parses the interaction data container 211 and extracts the interaction data 200 from the interaction data container 211 to instantiate the various modules 231, 232, 233, 234 to play back the interactive video. The four primary composer modules 212 to be instantiated are the layout and interaction module 231, annotation module 232, analytics module 233, and communications module 234.

This architecture has multiple independent Modules (e.g., 231, 232, 233, 234) and Sub-Modules (e.g., 231a, 231b, 231c, etc.) that perform functions defined by the interaction data container 211. Thus, additional interactions and interactive content is added by modifying the interaction data container 211 to introduce particular features and support for visualizations, tracking, providers, and other features. Therefore, the functionality and definition of modules and sub-modules outlined herein are merely examples of the various possible implementations consistent with this disclosure. The architecture therefore allows implementing new interaction functionalities independently from the video player as new modules and sub-modules are developed in the future.

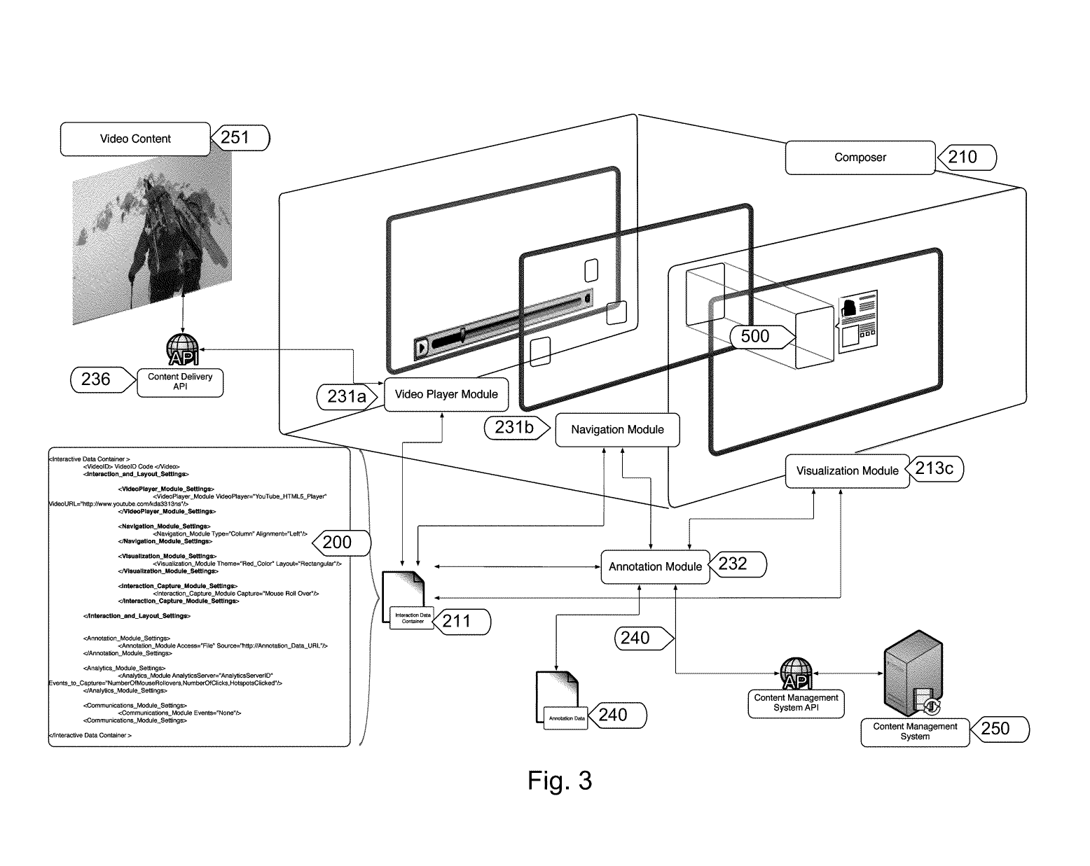

The layout and interaction module 231 is loaded to enable the viewer to interact with the video. FIG. 3 illustrates the architecture of the layout and interaction module 231 according to one embodiment. The layout and interaction module 231 loaded by the composer 210 instantiates as many “Layout and Interaction Sub-Modules” (231a, 231b, 231c, 231d, 231e as shown in FIG. 1B and FIG. 3) as required to show interactive content to viewers. These Sub-modules in one embodiment include the following: a video player module 231a, a navigation module 231b, visualization module 231c, an interaction capture module 231d, and gallery module 231e. Each of these Sub-Modules 231a, 231b, 231c, 231d, 231e performs tasks according to instructions specified in the Interaction Data Container 211.

The Layout and Interaction Module 231 enables the playback of the non-interactive content and interactive content to the viewer, and defines how the hotspots and annotation data 240 is presented. To present the annotation data, the layout and interaction module 231 receives the annotation data 240 from the annotation module 232.

The video player module 231a, as shown in FIG. 3, allows the play back of the non-interactive video content, accessing it by means of a Content Delivery API 236. The Content Delivery API 236 varies depending on where the video content is hosted (i.e., by an online video sharing service provider or on a hard drive, etc.) and how it is delivered (i.e., by which media streaming protocol), and is outside the scope of the present invention. However, the Video Player Module 231 a may have as many implementations as there are content delivery APIs providers. For example, in order to play back an interactive video whose original video content is an online video from YOUTUBE™, the composer 210 loads the “YOUTUBE™ Player Module.” The video player module 231 a can play back an online video using different media streaming protocols (e.g., HTTP progressive download, HLS, RTMP, RTSP, etc.), diverse online video formats (e.g., Flash video, HTML5 video, etc.), and access online video sharing service providers. The interaction data container 211 specifies which video player module 231 a to load as well as the location of the video content.

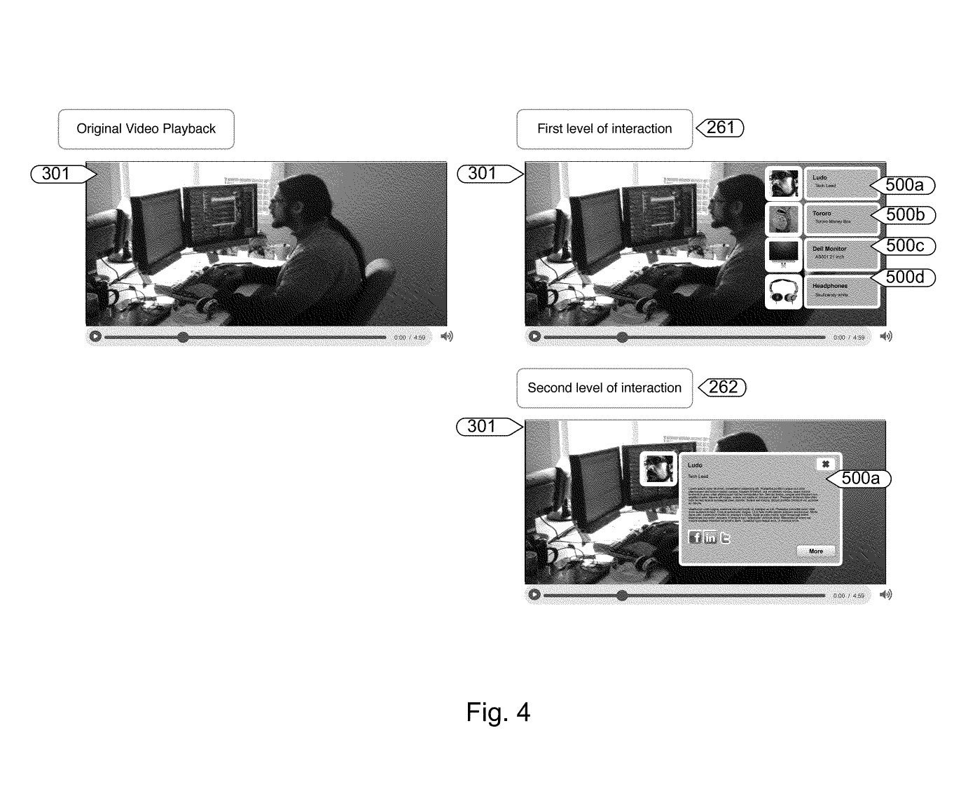

The Visualization Module 231c defines the way hotspots appear when selected by the viewer, and can be more clearly explained by referring to FIG. 4. FIG. 4 shows screenshots of interactive video according to one embodiment. The Navigation module 231b enables and defines, the display of a first level of interaction 261, as shown in FIG. 4. Initially, the viewer that may have no interactive elements or hotspots visible in the video. However, in some videos, interactive elements are present at the beginning of the video. When the viewer chooses to start interacting with the interactive video, he can provide an interaction event, such as by rolling his mouse cursor over the Interactive video, clicking the Interactive video, or, on a touch screen, touching the video. These interaction events are recognized is defined by interaction settings and may be included in interaction data container 211.

When the viewer provides an interaction event, a first level of interaction 261 is revealed. In one embodiment, no interaction is needed to reveal the first level of interaction 261, and the first level of interaction 261 is shown whenever interactive element are associated with that time in the video. The first level of interaction 261 in this embodiment includes four small thumbnails. Each thumbnail reveals just a small bit of information about certain elements appearing in the Interactive video. In this example, we see a person (“Ludo” 500a) and three objects (Tororo 500b, a monitor 500c, and a pair of headphones 500d) in the Interactive video, and when the Viewer commences interaction, these elements appear as Hotspots (500a, 500b, 500c, 500d) on the right hand side of the screen of the Interactive video. Note the top hotspot 500a revealed in particular is the name and brief description of the person appearing in the Interactive video; here, we learn that the person in the Interactive video is an individual named “Ludo” who is the “Tech Lead”, according to the thumbnail the Viewer is viewing. Next, the Viewer may decide to interact with the hotspot associated with Ludo to learn additional information. Still referring to FIG. 4, the Viewer “selects” the thumbnail of Ludo through an interaction event to yield the Second Level of Interaction 262, which provides yet even more detailed information about the hotspot.

The annotation data used in the hotspots, such as the second level of interaction 262, may be obtained from a third party feed, such as from a social network. Furthermore, social networking icons at the bottom of the Second Level of Interaction 262 permit the viewer to share the information on social media sites by posting a link to the viewer's online social media page. When the system receives an interaction with the social media link, the system transmits the hotspot information and user information to the applicable social network to post the information.

The visualization module 231c loads layouts for specific types of hotspots and manages the location of and interaction for items in the hotspot, such as a picture, description, and name. Each type of content may have one or more layouts. The visualization module 231c supports various implementations as well as interaction levels as defined by the interaction data container 211. For example, in the interactive video of FIG. 4, the viewer interacting with the “More” button provides further information about the hotspot 500a displayed in a “Third Level of Interaction” (not shown). Like the other levels of interaction, the third level of interaction may provide information related to the hotspot from additional sites. For example, the first level of interaction for a location may indicate “green hill road,” while the second level provides additional detail about this location, and the third level of interaction provides a data feed from a mapping service indicating the specific location of the road. The levels of interaction may load information in an embedded frame or may redirect the browser to another page or to a hotspot in another video.

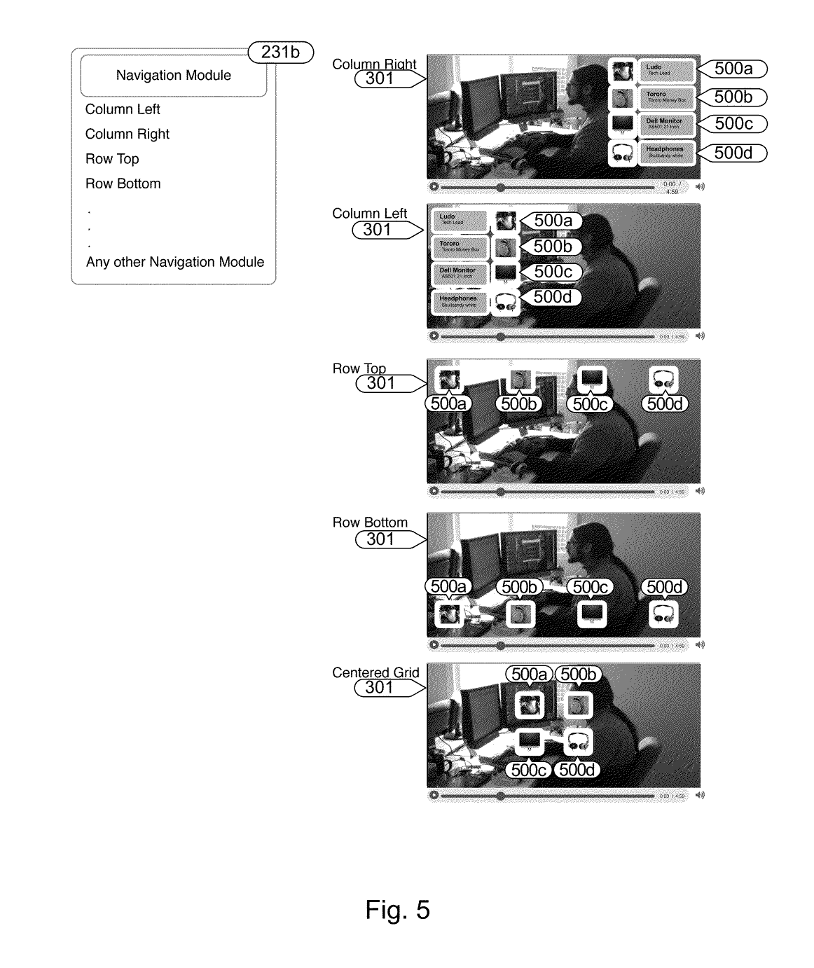

FIG. 5 illustrates a variety of navigation layouts according to various embodiments. The navigation layouts are loaded by the Navigation Module 231b. The navigation layouts for hotspots 500a, 500b, 500c, 500d available at the moment the viewer interacts with the video. In this particular example, five navigation layouts are presented: “Column Right,” “Column Left,” “Row Top”, “Row Bottom,” and “Centered Grid.” These different layouts of the Hotspots 500a, 500b, 500c, 500d are each illustrated in FIG. 5, additional navigation layouts may be used. The interactive video composer 210 supports all five layouts; however, when playing back the interactive video, the composer 210 loads the module stated in the interaction data container 211 to display a particular layout for the selected interactive video. In one embodiment, the hotspots 500 are associated with the video content based on the time in the video. That is, there is a time relationship between hotspots 500 and video content that defines when (and which) hotspots are shown on a video. This is termed a “timeline annotation scheme” reflecting the association of hotspots with a timeline.

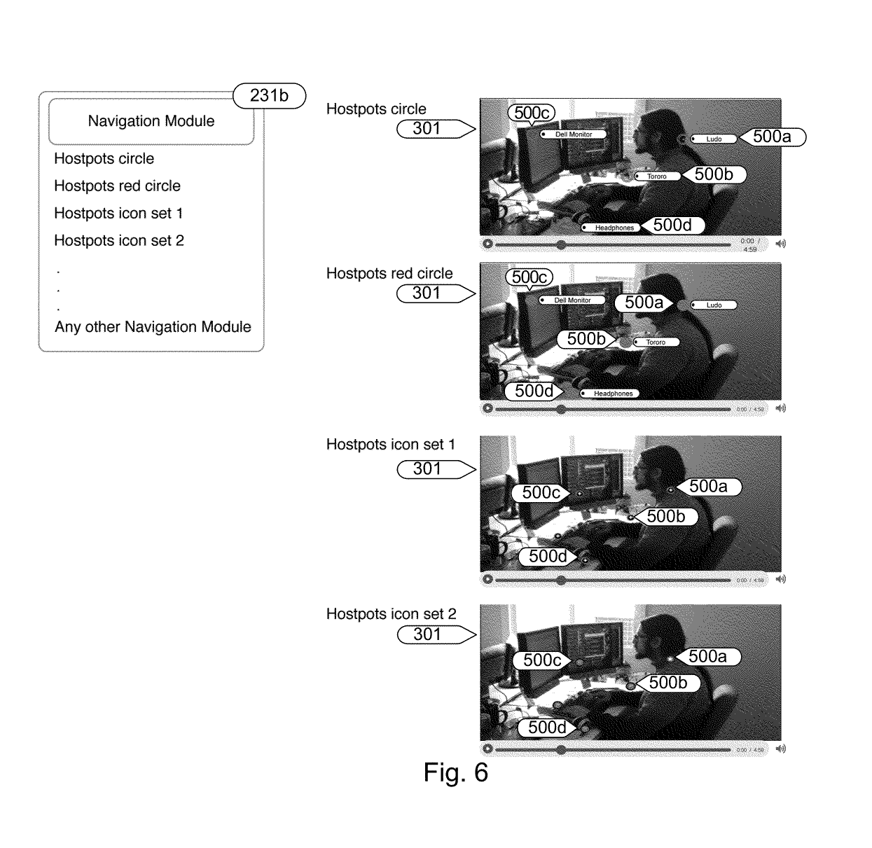

FIG. 6 shows a further layout of hotspots for user interaction with an interactive video according to one embodiment. In this embodiment, navigation module 231b and hotspots 500 implement a “tracking annotation scheme.” In this example, the interactive video not only displays when Hotspots 500a, 500b, 500c, 500d appear at a particular time within the video, but also a location in the video frame at which to place the hotspot. The appearance (or “look and feel”) of the Hotspots 500a, 500b, 500c, 500d is defined by the interactive video creator. As shown in FIG. 6, the Hotspots 500a, 500b, 500c, 500d may have various styles, such as a round circle, a solid red circle, or a black circle with a “plus” sign in the middle, and other shapes and colors. Hotspots 500 can also be indicated by specific icons to make the viewer note that there are different categories of hotspots 500 (e.g., a small human-like head could indicate a hotspot with information about a person, or a small musical note could indicate the presence of a hotspot with information about the music in the background.) For example, referring to the last image in FIG. 6, hotspot 500a is an icon of the silhouette of a human head indicating that the hotspot 500a has information about a person. Hotspots 500b, 500c, and 500d are objects/products (i.e., Tororo, a monitor, and headphones, respectively) and are each represented by small shopping cart icons, which indicate the viewer can click on one of these hotspots 500b, 500c, 500d, learn more about the product, and ultimately be directed to a website to enable purchase the product. A hotspot could also be represented by a grid, indicating the presence of a map showing the location of where the video took place and/or a place (such as a restaurant or grocery store) appearing in the video. Each of these indicate the presence of a hotspot 500, and the style of the hotspot indicates the type of annotation associated with hotspot.

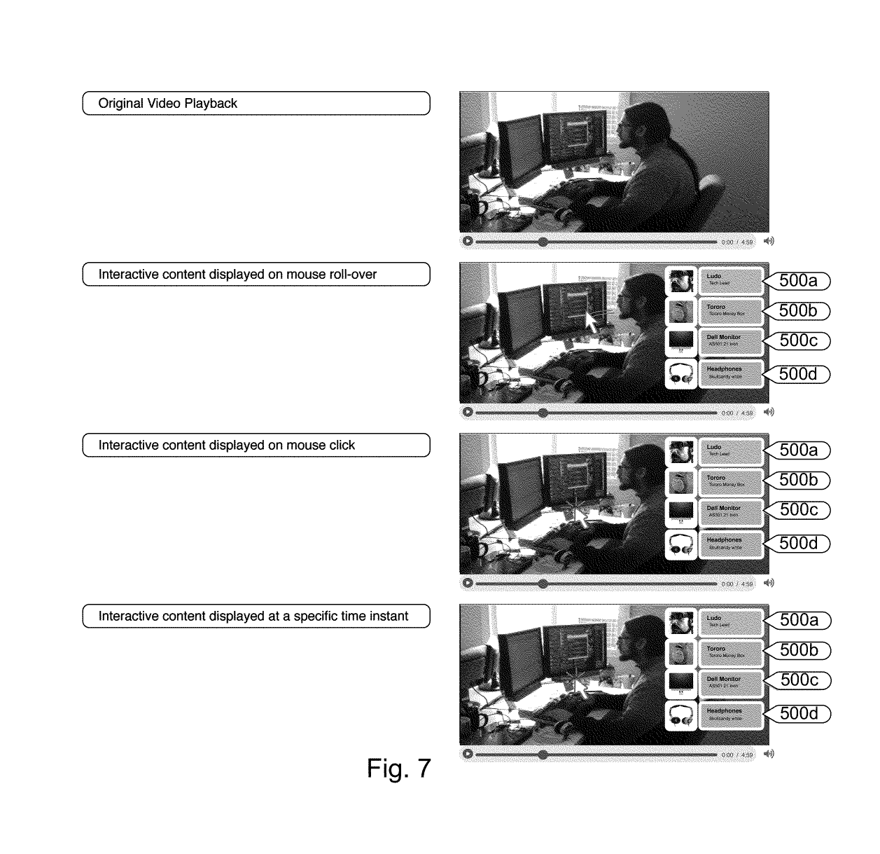

FIG. 7 shows screenshots with example interactions of hotspots with a viewer according to one embodiment. These interactions may be implemented by the interaction capture module 231 d, which defines the way the interaction with viewers will behave. As one example, the top image shown original video playback. The next image shows that during Interactive video playback, Hotspots 500a, 500b, 500c, 500d will appear simply when the viewer rolls his mouse cursor over the Interactive video. As another example, the third image shows that during interactive video playback, hotspots 500a, 500b, 500c, 500d will appear when the viewer clicks on the interactive video. As a final example, the fourth image shows that during Interactive video playback, Hotspots 500a, 500b, 500c, 500d will appear at a specific time instance of the video. Each of these methods may be used together or separately to trigger display of various hotspots or further annotations. These examples show that the Interaction Capture Module 231d defines how the Interactive video will behave and react by displaying different effects and present diverse behavior when a viewer clicks on the Interactive video or moves his mouse cursor over a particular area of the interactive video.

Referring to FIG. 1B, the annotation module 232 may also include an embedded annotation parser module (not shown). This Module extracts the Annotation Data 240 directly from the video content, rather than getting the data from the Annotation Data 240.

The Gallery Module 231e allows viewing of hotspots 500 as a thumbnail gallery, which contributes to the overall “look and feel” of the Interactive video.

Additional interaction and layout modules may be used to support additional interactive features. The described interaction and layout modules may be selected for loading in a given interactive video player based on whether the module's functionality is used by the interaction data.

While the Layout and Interaction Module 231 instructs the video player on what to do, the Annotation Module 232 determines what Annotation Data 240 is shown. The Annotation Data 240 is media content related to the Interactive video (e.g., hotspots 500 or other related metadata), which have a specific meaning for the Video Content 251. The annotation data is associated with a timeline of the video (e.g., designating a start and stop time for the hotspot to be displayed), and may also be associated with tracking an object in the video as described above.

The annotation data may be associated with a variety of “Annotation Schemes”; that is, how Annotation Data 240 are related to the original Video Content 251. For example, the Content Creator can decide if the content he wants to make interactive is only displayed at specific times (i.e., timeline annotation) as described above with reference to FIG. 5 or tracking the object he is tagging as shown in FIG. 6. The Annotation Scheme is typically specified by the Content Creator during the Interactive Video creation process.

In a “Timeline Annotation,” the Annotation Data 240 has a time relationship with the original Video Content 251, and the Content Creator creates Hotspots 500 which relate to a particular instant of time within the video (e.g., Hotspot 500 is active/displayed in the Interactive video between the time instants 0:32 and 1:32, later again between time instances 2:31 and 2:53, and so on). Here, the annotations of hotspots 500 have a relationship during specific times with the interactive video. So, when a viewer interacts with the Interactive video at these times with his mouse cursor, he will see the hotspots 500. This embodiment for displaying hotspots is not associated with a particular location in the video.

In another embodiment, termed a “hotspot tracking annotation,” annotation data 240 has a time and location (or spatial) relationship with the video content 251. The location is the spatial trajectory or path along timeframes within the video and defines motion of the hotspot 500 during the Interactive video. This way, the motion of the Hotspot 500 along the time of the video is displayed to the user. For example, FIG. 6 shows an interactive video when following the “Hotspot Tracking Annotation” scheme. The Interactive Video Player will show these four Hotspots 500a, 500b, 500c, 500d and their location in the video only if they are present in the particular time the Viewer chooses to interact with the video (e.g., such as by rolling his mouse cursor over the Interactive video).

A third Annotation Scheme combines both previously described Annotation Schemes. An Interactive video may include hotspots 500 which have only a time relationship with the video content 251 (e.g., the music of a film or the location of a specific scene), and the others that have both a temporal and a spatial relationship with the video content 251 (i.e., the face of the main character of a movie)

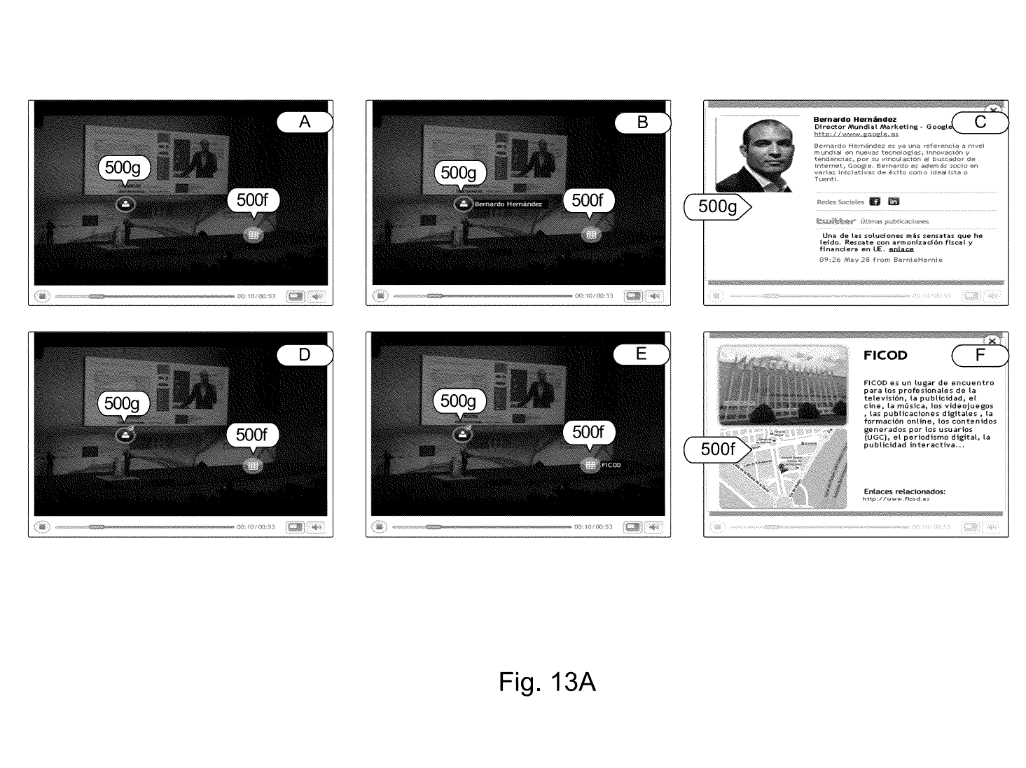

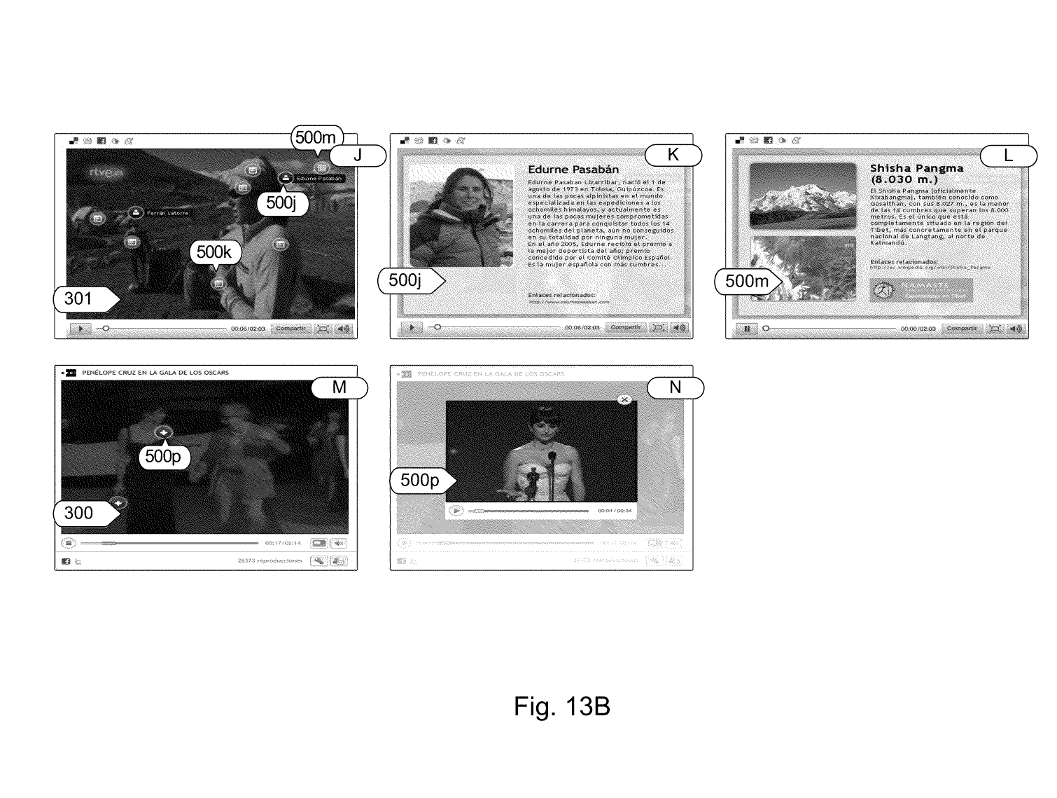

Referring to FIG. 1B, the data feed module accesses data feeds to access dynamic annotation data. The annotation data 240 can be retrieved by the system of the present invention from third party systems, such as data feeds from social networks, news sites, or another third party content management system 250. As an example, Image C shown in FIG. 13, shows dynamic annotation data 240 of Hotspot 500g as a social networking feed derived directly from the social network.

In addition, annotation data 240 can be user-generated comments on a hotspot. When a viewer interacts with a hotspot, depending on the hotspot definitions, the viewer may add user remarks or comments to the hotspot. The remarks are transmitted to the stored annotation data 240 and may be displayed to other users. The content creator may define whether comments can be added and thus included as annotation data 240.

Furthermore, the annotations provide multi-country and multi-language support. The annotation data 240 can be different, or provided in different languages, depending on the different location of the viewer or different language of the viewer. In other words, there is a single underlying video, but the annotation data 240 determines which language is shown to the user. The annotation data 240 specifies which language must be selected when playing back the interactive video. The system has the ability to display the Annotation Data 240 in a specific language or country content settings. For example, if the viewer viewed a pair of shoes on an e-commerce website, the information could reveal 99 Euros if being viewed from France, $89USD if being viewed from the US, and 120GBP if being viewed from the UK, and the language of the products would depend on the country where it was being viewed from. These differences are defined in the annotation data and which hotspot annotation to use is selected based on the country and language actually used by the user device 110.

Referring back to FIG. 1B and FIG. 2, the analytic module tracks user interaction with an interactive video. Depending on the events desired to be logged, different sub-modules (e.g., analytics provider module 233a, click tracker module 233b, play length module 233c, Roll-Over Tracker Module 233d) are loaded in the same way that the layout and interaction module 231 and sub-modules were loaded. Specific sub-modules are loaded and capture specific types of events on the interactive video. For example, the click tracker module 233b tracks how often and where on the Interactive video a hotspot 500 was clicked. As another example, a play length module 233c tracks how long a viewer stayed on (or viewed) a particular Interactive video. As another example, a roll-over tracker module 233d tracks the viewer's mouse cursor rollover on the interactive video. As a final example, an analytics provider module 233a would serve to allow analysis of all these different types of events.

The analytics module 233 tracks and logs data about viewers that played back the Interactive video. The interaction of viewers with the system is tracked and reported to analytical servers. The analytics module 233 assists in determining, for example, which version of annotations is preferred by users. For example, the number of clicks could indicate a more marketable annotation marketing campaign. Alternatively, which fashions are more favorable in a video could be determined by knowing the number of clicks on a particular dress or shirt.

Next, referring back again to FIG. 1B, FIG. 1C and FIG. 2, the communications module 234 is loaded along with the necessary modules and sub-modules (e.g., Host Site API Module 234a. Event Sender Module 234b) to allow communication between the composer 201 and host 130 (i.e., the website which loaded the Interactive Video Player Container 100) allowing the system of the present invention to send notifications (i.e., “events”) to the website embedding the interactive video player container 100. When the website receives the event, the website may display additional details or other information to the user based on the type of event. For this particular implementation of the interactive video player container 100, the Host 130 is the website which loads the Interactive Video Player Container 100, as shown in FIG. 1A and 1C.

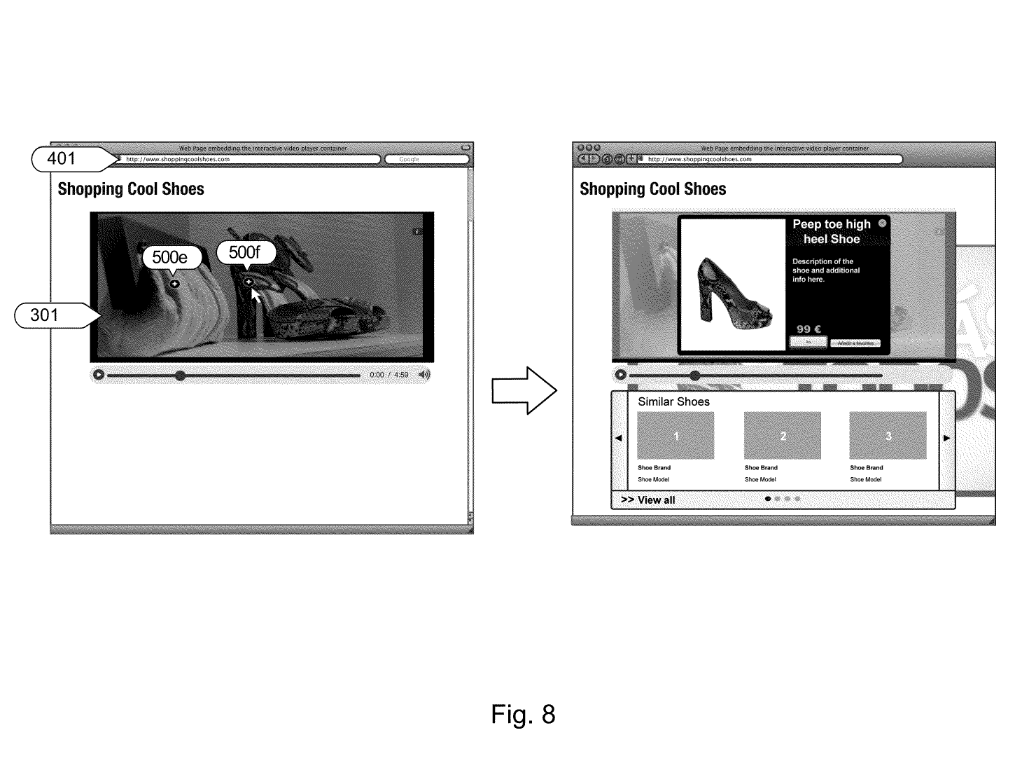

FIG. 8 illustrates screenshots of an example modification of a webpage based on an interaction event according to one embodiment. In FIG. 8, the screenshots show a fashion-related video. The interactive video reveals two hotspots (e.g., a purse 500e and shoes 500f) that the viewer can explore, as shown in the first image. The viewer can elect to interact with the interactive video to find out more information about these hotspots 500e, 500f displayed at a specific time during the play back of the interactive video. If the viewer selects the shoe hotspot 500f, the Annotation Data 240 of the shoe hotspot 500f is displayed, as shown in the second image in FIG. 8, and the Communications Module 234 will then send an “event” to the website Host 401 (here, www.shoppingcoolshoes.com) indicating the shoe hotspot 500f was selected by the user.

On receipt of the event, the website may change its display responsive to the event generated by the user. The second screenshot shows the website with a different layout relevant to the Hotspot 500f selected by the Viewer. In the example of FIG. 8, the website changed the wallpaper image and showed a product “carousel” with similar products relevant to the hotspot 500f selected by the Viewer. In this example, the website is “event-driven”; that is, it can process the events sent by the player and change its behavior by editing the layout and displaying a product carousel. The communications module 234 sends these events to the host 401 site that embeds the container 100 and enables the host 401 to modify its behavior on receipt of an event.

In one embodiment, the interactive video player receives events from the host site 401. The host site 401 may provide a display to the user of all hotspots available in a video. When a user selects a hotspot, the selection of the hotspot at the host site 401 is transmitted to the interactive video player. The communications module 234 receives these events from the hot site 401 and the interaction data file determines the behavior to perform on receipt of the event. For example, when the interaction is the user selection of a hotspot on the host site 401, the interactive video player sets the time of the video to a time at which the hotspots appears, such as the first time the hotspot appears in the video. In other embodiments, the annotation data includes hotspots, where some or all of the hotspots are selectively shown to the user based on the events. For example, the hotspots may include clothes for a fashion show, including hotspots for the designer, dresses, pants, shoes, etc. The host site may include selections for the user to view only one type of hotspot, such as the designer. When a user selects to view only the designer, The user's selection is transmitted to the interactive video player, which receives the selection and shows only hotspots related to the selection.

These embodiments of an interactive video player has the structure of modules and sub-modules that will execute instructions as directed by the interaction data file instructs. The interactive video player is modular and scalable, and has as many different modules and sub-modules as needed or specified. These Modules and Sub-Modules can be implemented to suit specific needs and requirements. The addition and subtraction of modules provides flexibility and support for new ways of interaction, creating new content, providing different visualization, tracking/timing, and support new video platform companies and providers as they are developed.

Referring to FIG. 1B, after the interactive player modules as described above have been loaded, the interactive video player initiates playback 300. During playback, viewer interaction analytics are captured 400. Viewer interaction logging captures video playback events so that Content Creators of the Interactive video can track viewer interaction and statistics, as shown in FIG. 1B. The analytics module 233 described above captures these user interactions. This process may collect as many events from the interactive video playback as desired, to be later sent to an analytics service. Once these interaction logging data are stored in an analytics service, they can be analyzed, and statistical reports can be produced.

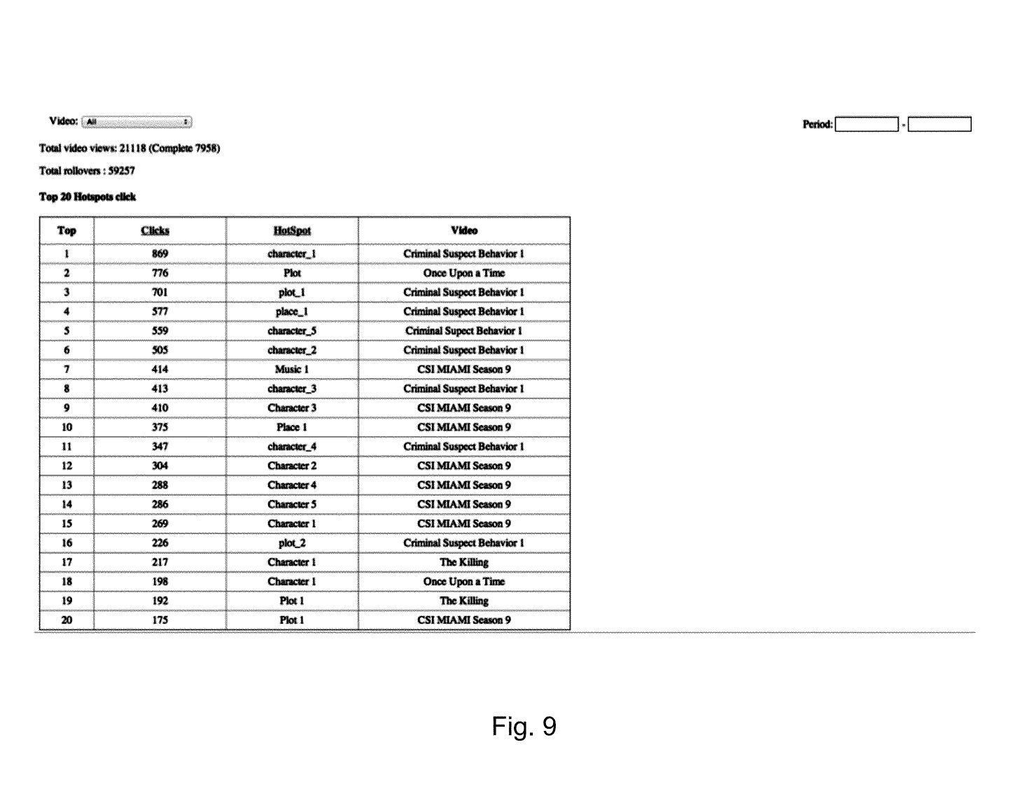

FIG. 9 illustrates an example statistical report of user analytics according to one embodiment. This report indicates which videos were viewed, what top hotspots were clicked, and how many times they were each clicked. Such information would help the Content Creator deduce which Hotspots were the most attractive to the consumer.

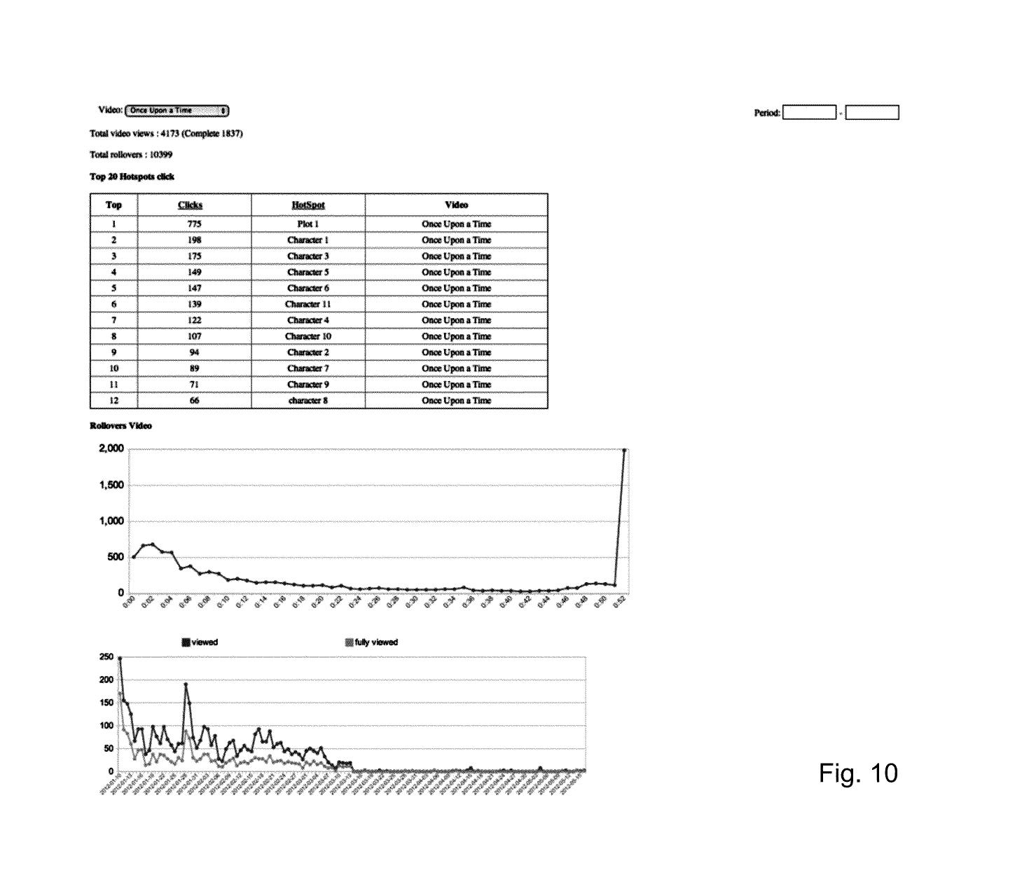

FIG. 10 illustrates another example statistical report of user analytics according to one embodiment. The content creator can choose a specific video, and see which hotspots were the most popular within that single video. The report indicates how many times a viewer rolled over the video, at what time within the video, and how many times a viewer watched an Interactive video in its entirety.

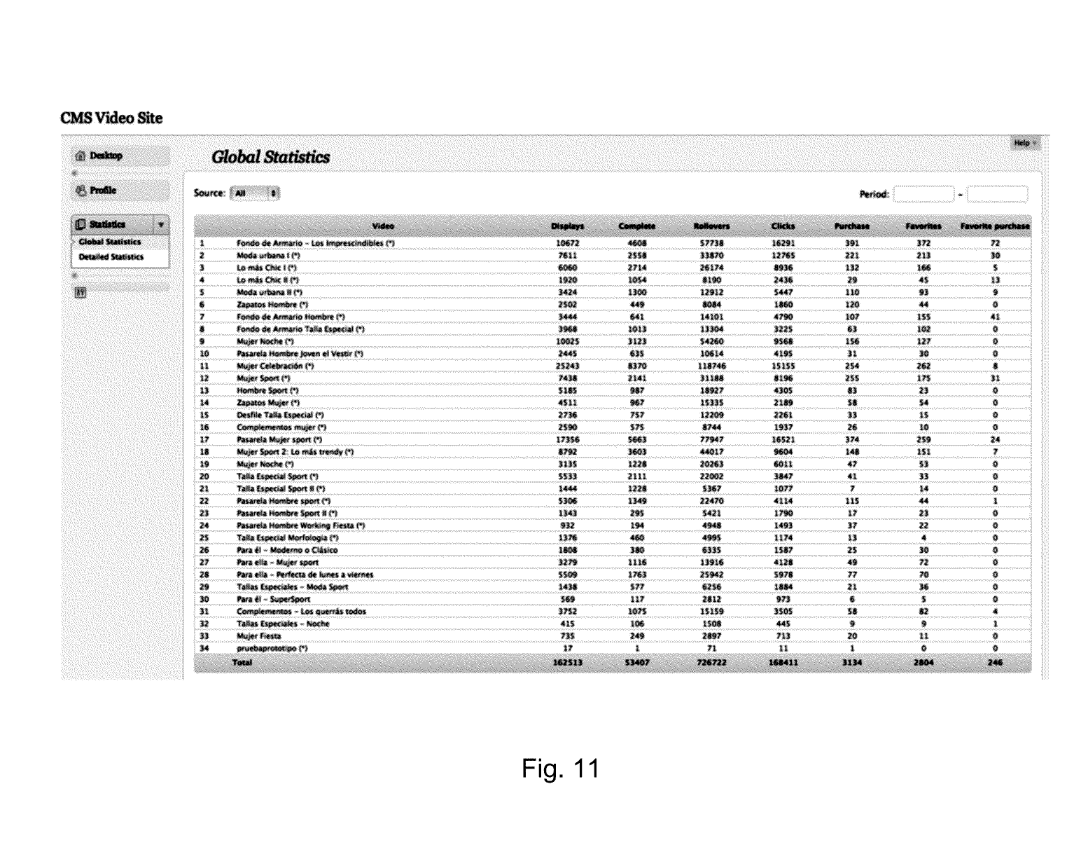

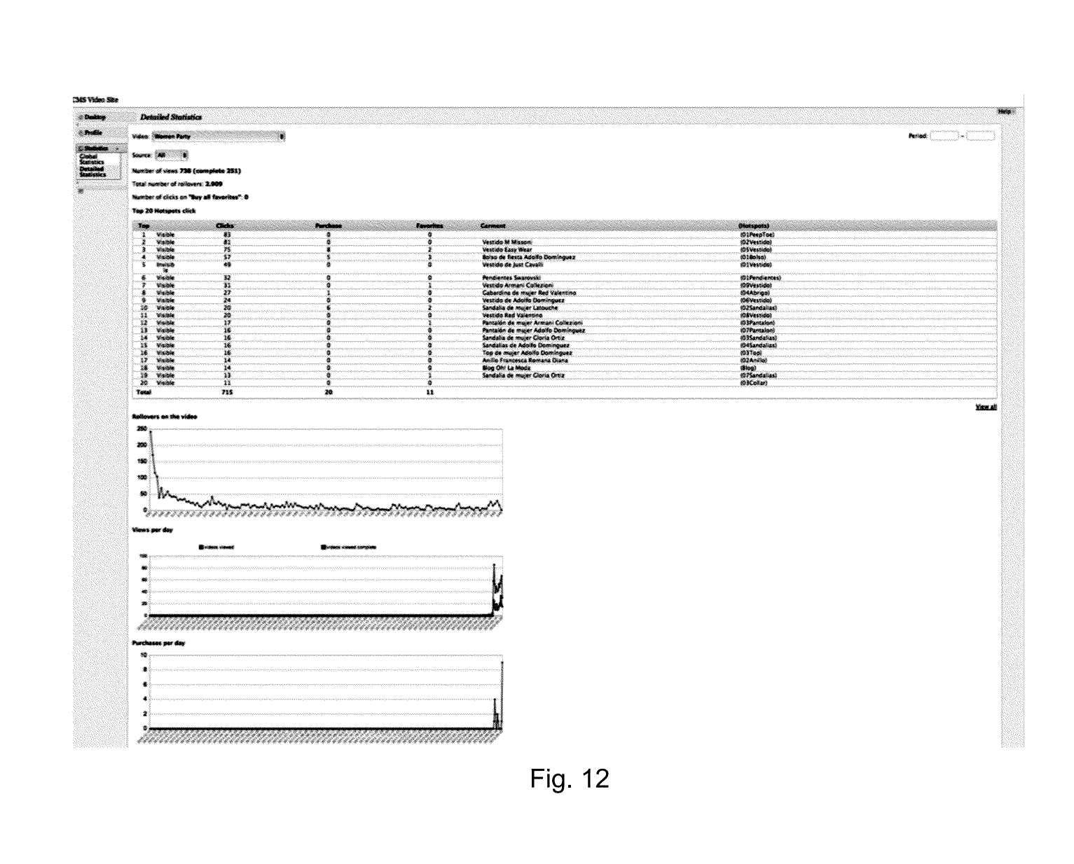

FIGS. 11 and 12 illustrate additional example statistical reports of user analytics according to one embodiment. Using these reports, a Content Creator could determine which videos were watched, which ones were watched in their entirety, how many mouse rollovers occurred, the number of clicks on a particular hotspot, and the number of purchases originating from the clicked image. Further, the analytics module 234 can collect the IP address of the user device. This allows a report to infer geographic information based on the IP addresses where the video was played. These statistical reports are example statistics; additional statistics may be determined as desired by the analysis system.

### Method Overview—Play Back of Interactive Video

There are multiple possible ways a viewer may interact with the Interactive video. When a viewer is watching an Interactive video and interacts with a hotspot, the video may or may not pause, depending on the specific Layout and Interaction Module 231. When the viewer interacts with the video (such as rolling his mouse curser over the Interactive video or the event-mouse-click, or hotspots always shown at a specific time, etc.), hotspots 500 may appear within the scene, and each hotspot 500 will be indicated by a small “icon” or any other layout.

In one embodiment, when the viewer rolls over the hotspot icon, a small bar of data is displayed in a first level of interaction 261, displaying a brief element of data (e.g., the name of the person at the hotspot 500), as described with respect to FIG. 4. Clicking on the icon will then reveal more data (i.e., the second level of interaction 262), which may be displayed in several different ways, such as, but not limited to, a screenshot embedded within the Interactive video, an embedded within the video, etc.

If the hotspot tags places or locations, map data can be embedded into the video, so when a viewer clicks on hotspot 500 that looks like a small grid icon signifying a place or location, a picture of the location and the map will appear. Clicking on the picture of the location, as shown in Screenshot E in FIG. 13, will take the viewer to the location mapping service with the location set in the Hotspot 500f as shown in Screenshot F.

Another example of interaction is tagging people. A small “human” icon will appear on a person, and clicking on this hotspot 500 will load data that has been annotated about the person in the video, or data fed from third party platforms, such as a social network, database, or news feed. The most recent events from a user's feed may be listed in the annotations.

FIGS. 13A and 13B show examples of interactive video playback 300 associated interactions according to one embodiment.

In FIG. 13A, Screenshot A displays a screenshot of an interactive video with two hotspots 500f and 500g following the Tracking Annotation Scheme, described in detail above. Each hotspot 500f and 500f has a different small icon indicating that they are of different types of hotspots. Next, screenshot B shows what happens when a viewer rolls his mouse cursor over (or “clicks” on) the hotspot 500g with a “human” icon: the name of the person annotated in that hotspot 500g is displayed in a first level of interaction 261. When the viewer clicks on that hotspot 500g, even more information (i.e., Annotation Data 240) about the selected person is displayed, as shown in Screenshot C, in a second level of interaction 262.

In screenshot C, the annotation data 240 about the individual includes static data (such as name, position and description) and dynamic data, which are directly retrieved from a social networking feed. The next time another viewer a clicks on this hotspot 500g, perhaps at a later date, the social networking feed will be updated for any new events on the social networking feed. However, the static annotation data 240 will remain the same.

Next, the Viewer may close the second level of interaction 262 shown in Screenshot C by clicking on the “x” on the top right of the screen. Screenshot D and Screenshot E show how the Interactive Video Player indicates to the viewer that the Hotspot 500g has already been opened and viewed by displaying a checkmark. Of course, any type of relevant indicator can be used, and is not limited to a checkmark. Next, Screenshot E shows what happens when a viewer interacts with the Hotspot 500f with a “map grid” icon: the name of the location annotated in that Hotspot 500f is displayed in a first level of interaction 261.

When the Viewer clicks on or otherwise further interacts with that hotspot 500f, more information (i.e., Annotation Data 240) about that location is displayed, as shown in Screenshot F, in a second level of interaction 262. Here, Screenshot F shows a “location” Hotspot 500f displayed with a mapping service.

Another interaction sequence is shown in FIG. 13B according to one embodiment. In FIG. 13B, screenshot J displays a screenshot of an Interactive video having multiple Hotspots 500j, 500k, 500m. Each Hotspot 500j, 500k, 500m has a different small icon indicating that they are of different “types” of hotspots 500 (a small human icon to show information about a person 500j, an orange “product tag” icon to show information about a product or object 500k, and a green map icon to reveal the location, such as via a mapping service 500m). Screenshot J shows a user interaction with (e.g., rolls over or “clicks” on) the hotspot 500j with a “human” icon: the name of the person annotated in that Hotspot 500j is displayed in a First Level of Interaction 261: “Edurne Pasaban.”

When the viewer clicks on that hotspot 500j, even more information (i.e., Annotation Data 240) about Edurne Pasaban is displayed, as shown in Screenshot K, in a second level of interaction 262. In Screenshot L, we can see more information about hotspot 500m, that is, the mountain Shisha Pangma.

As yet another example, refer to FIG. 13B, Screenshot M. Here, there are several hotspots on Penelope Cruz, one in particular is hotspot 500p. Clicking on hotspot 500p reveals an additional informational video about Penelope Cruz, as shown in Screenshot N. As shown in this example, an information video can be embedded in the interactive video. Thus, a wide range of information resources that can be embedded.

Another example of viewer interaction with interactive video includes interacting with would be embedding games within the video at a hotspots 500 relevant to the video.

The system of the present invention can be played back on many different devices or platform technologies, including, but not limited to, web browsers, SmartTVs, Smartphones, etc. Even further, interactive video will not be able to load if a certain video isn't allowed in a particular geographic territory. A blacklist of countries, domains or ISP addresses can be set to prevent play back of interactive videos 301, or certain restrictions can be defined within the video that disallows video playback. For example, if a company develops an advertising campaign that might be culturally unacceptable in a particular country, certain restrictions can be set on the interactive video so that either the Interactive video doesn't play, or the Hotspots 500 cannot be shown in that particular country.

These examples represented are for illustration purposes only, and the data contained within the illustrations are to be construed as examples only, and in no way should be interpreted so as to narrow the scope of this disclosure.

### Method Overview—Sharing of Interactive Video

The interactive video may also be shared, including Interactive Video Content 251 as well as specific hotspots 500, on social media. The method described herein may be implemented in the context of the functionality of the system described above.

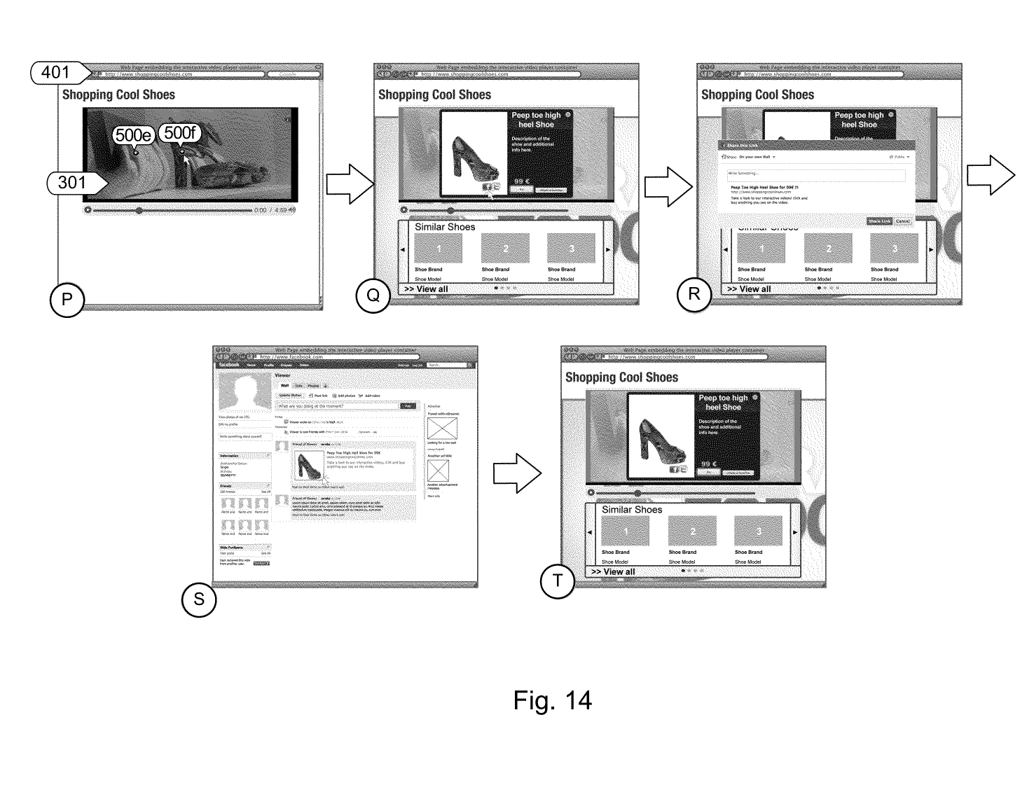

FIG. 14 displays a series of images that show a method of sharing according to one embodiment. Image P is a screenshot of a interactive video showing two hotspots 500e and 500f being viewed by a viewer. The arrow indicates the viewer's mouse cursor. When he rolls his mouse cursor over the video screen, the Hotspots 500e and 500f are displayed. In this instant example, this is a “Tracking Annotation Scheme” video, where annotation data is shown on the location of the Hotspots 500e and 500f. When the Viewer selects the Hotspot 500f showing shoes, such as by clicking on the Hotspot 500f, screenshot Q is displayed, which is a second level of interaction 262. The bottom of this screen shows social networking icons at the bottom of a second level of interaction 262, which permits the viewer to share the information about the selected hotspot relating to shoes to either social networking system by posting a link to the viewer's online social media feed.

Screenshot S shows how the posting of the Hotspot 500f would appear on the viewer's social media page. When another individual viewer a sees this posting on the viewer's page, if he a finds the hotspot 500f of interest, he can click on the posting (or image), the link directs the user to the web site 130 including the interactive video, which directs the individual to the annotated hotspot 500f, as shown in Image T. Whenever Viewer a clicks on the shared Hotspot 500f, the Interactive video is played back for the viewer with the same data (i.e., hotspot 500 content) that the viewer was seeing when he decided to initially share it, meaning that the viewer will “land” in the same time position within the Interactive video the shared interactive video.

When a social media network user (i.e., viewer a) clicks on the hotspot 500f shared by another social media network user (i.e., viewer) who initially viewed and shared the interactive video, the system of the present invention will start displaying the hotspot 500f the first viewer shared, and if viewer a decides to playback the video, this will be resumed exactly from the same time instant viewer chose to share it. A Viewer has the option to share an entire Interactive video, or just the specific Hotspot 500, which is particularly conducive to information “going viral.”

### Searchable Hotspots

In one embodiment, the annotation management system 140 publishes web pages relating to hotspots in videos associated with the annotation data 240. The hotspots published in the web pages are thereby searchable by search engines and can be indexed and browsed by users without accessing a host site 130 initially. The annotation data 240 associated with a particular tag (i.e., a topic) may also be associated with multiple videos. The page published by the annotation management system 140 includes a listing of the multiple videos related to the topic. For example, a page may publish a searchable page relating to a tag for a particular pair of shoes. The hotspots that include that tag are also listed on the page. Each of these hotspots is associated with a video for that hotspot. When the user selects one of the hotspots on the searchable page, the associated video is selected and begins play at the time at which the hotspot appears. This allows a user to easily search for tags and associated hotspots, e.g., on a search engine, and easily go to the portion of a video of interest for the hotspot related to the tag. Once a user selects a hotspot, an event is transmitted to the interactive video player to begin playback at the hotspot selected by the user. In one embodiment, the user selection of a hotspot is transmitted by the user as a link (e.g., a universal resource locator (URL)) that can be directly accessed by a user and shared to other users.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for providing an interactive video to a user, the method comprising:
playing a non-interactive video in an interactive video player container and displaying the playing video to a user;
accessing annotation data associated with the non-interactive video;
responsive to the playing non-interactive video reaching a time in the playing video associated with a begin time of the annotation data, displaying an interactable element describing the annotation data on a portion of the playing video;
receiving a user interaction with the interactable element;
in response to receiving the user interaction with the interactable element, displaying a second interactable element describing the annotation data on at least a portion of the playing video;
responsive to the playing non-interactive video reaching another time in the playing video associated with an end time of the annotation data, removing the interactable element from the portion of the playing video.

2. The method of claim 1 wherein the interactive video player container is retrieved from a webpage on a website.

3. The method of claim 2, further comprising transmitting event data reflecting the user interaction to the website in response to receiving the user interaction with the interactable element.

4. The method of claim 3, further comprising receiving an updated webpage generated by the website after transmitting event data to the website.

5. The method of claim 2, further comprising receiving, from the website, event data associated with user interaction at the website; and modifying the displayed interactable element based on the event data.

6. The method of claim 2, further comprising receiving, from the website, event data associated with user interaction at the website; and modifying the playing of the non-interactive video based on the event data.

7. The method of claim 1 wherein the annotation data is stored separately from the non-interactive video.

8. The method of claim 1, wherein the second interactable element provides additional detail regarding the annotation data.

9. The method of claim 1, wherein displaying the second interactable element comprises accessing a network address to retrieve additional data associated with the annotation data and the second interactable element includes the additional data.

10. The method of claim 9, wherein the additional data consists of one of: social networking information, map information, product information, advertising information, and any combination thereof

11. The method of claim 1, wherein the annotation data includes a plurality of hotspots each associated with a start time and stop time in the non-interactive video and therein displaying the annotation data comprises displaying the hotspots with a start time prior to a current time of the playing non-interactive video and a stop time after the current time of the playing non-interactive video.

12. The method of claim 11, wherein each of the plurality of hotspots is associated with at least one spatial location in the non-interactive video.

13. The method of claim 1, wherein the playing video is paused while the second interactable element is displayed.

14. A system for providing an interactive video to a user, the system comprising:
a processor configured for executing instructions;
instructions executable on the processor, which when executed cause the processor to:
play a non-interactive video in an interactive video player container and displaying the playing video to a user;
access annotation data associated with the non-interactive video;
responsive to the playing non-interactive video reaching a time in the playing video associated with a begin time of the annotation data, display an interactable element describing the annotation data on a portion of the playing video;
receive a user interaction with the interactable element;
in response to receiving the user interaction with the interactable element, display a second interactable element describing the annotation data on at least a portion of the playing video;
responsive to the playing non-interactive video reaching another time in the playing video associated with an end time of the annotation data, remove the interactable element from the portion of the playing video.

15. The system of claim 14 wherein the interactive video player container is retrieved from a webpage on a website.

16. The system of claim 15, wherein the instructions further cause the processor to transmit event data reflecting the user interaction to the website in response to receiving the user interaction with the interactable element.

17. The system of claim 16, wherein the instructions further cause the processor to receive an updated webpage generated by the website after transmitting event data to the website.

18. The system of claim 15, wherein the instructions further cause the processor to receive, from the website, event data associated with user interaction at the website; and modify the displayed interactable element based on the event data.

19. The system of claim 15, wherein the instructions further cause the processor to receive, from the website, event data associated with user interaction at the website; and modify the playing of the non-interactive video based on the event data.

20. The system of claim 14 wherein the annotation data is stored separately from the non-interactive video.

21. The system of claim 14, wherein the second interactable element provides additional detail regarding the annotation data.

22. The system of claim 14, wherein displaying the second interactable element comprises accessing a network address to retrieve additional data associated with the annotation data and the second interactable element includes the additional data.

23. The system of claim 22, wherein the additional data consists of one of: social networking information, map information, product information, advertising information, and any combination thereof.

24. The system of claim 14, wherein the annotation data includes a plurality of hotspots each associated with a start time and stop time in the non-interactive video and therein displaying the annotation data comprises displaying the hotspots with a start time prior to a current time of the playing non-interactive video and a stop time after the current time of the playing non-interactive video.

25. The system of claim 24, wherein each of the plurality of hotspots is associated with at least one spatial location in the non-interactive video.

26. The system of claim 14, wherein the playing video is paused while the second interactable element is displayed.
